(19) United States
(12) Patent Application Publication
(10) Pub. No.: US 2012/0173851 A1
(43) Pub. Date: Jul. 5, 2012

(54) MECHANISM FOR MAINTAINING DYNAMIC REGISTER-LEVEL MEMORY-MODE FLAGS IN A VIRTUAL MACHINE SYSTEM

(75) Inventor: Michael D. Lewis, Sanford, NC (US)

(73) Assignee: International Business Machines Corporation, Armonk, NY (US)

(21) Appl. No.: 12/982,829

(22) Filed: Dec. 30, 2010

(51) Int. Cl. G06F 9/30

(52) U.S. Cl. 712/208; 712/E09.028

(57) ABSTRACT

A method for maintaining dynamic register-level memory-mode flags in a virtual machine includes parsing a machine instruction of a live memory analysis command in a virtual machine (VM). The machine instruction can include an instruction opcode, a source address referring to a first type of memory and a destination address referring to a second type of memory. A register bitmap can be stored as a register-level memory-mode flag array. Thereafter, it can be determined whether or not the instruction opcode maps to an inheritance class. Finally, in response to a bit in the register-level memory mode flag array referencing virtual memory and the instruction opcode being mapped to an inheritance class, the register bitmap can be replaced with new bit values that represent redefined memory types for each register represented in the register bitmap. Subsequently, the new register bitmap can be used in simulation of a next machine instruction of a live memory analysis command executing in the virtual machine.

### BACKGROUND OF THE INVENTION

1. Field of the Invention

The present invention relates to the field of memory analysis commands and more particularly to maintaining dynamic register-level memory-mode flags in a computing system.

2. Description of the Related Art

Standard mainframe hardware supports two modes of referencing memory by register when executing a single machine instruction—Dynamic Address Translation “on” and “off.” Dynamic address translation, or DAT, is the process of translating a virtual address during a storage reference into the corresponding real address. If the virtual address already resides in central storage, the DAT process may be accelerated through the use of a translation look aside buffer. If the virtual address is not in central storage, a page fault interrupt occurs, the operating system is notified and the DAT process can load the desired page of memory from auxiliary storage. Of note, a DAT switch indicates whether a program is accessing real on real memory or virtual on real memory. The DAT switch—a one-bit setting—is global in nature, in that all registers involved with addressing memory within the executing machine instruction reference the same kind of memory—DAT “on” or DAT “off.”

Generally, the DAT switch setting applies to the execution of a collection of machine instructions. For instance, when referring to virtual memory on real memory, in order for a set of machine instructions to retrieve contents from virtual memory, DAT must be set to “on.” When DAT has been set to “off” the machine instructions can retrieve contents from real memory on real memory. DAT can be implemented by both hardware and software through the use of page tables, segment tables, region tables and translation look aside buffers. DAT allows different address spaces to share the same program or other data that is for read only. This is because virtual addresses in different address spaces can be made to translate to the same frame of central storage. Otherwise, there would have to be many copies of the program or data, one for each address space.

A problem arises, however, when a single machine instruction refers to two “flavors” of memory: real and virtual. For instance, in the context of the command “Move X to Y,” the contents of X may be in real memory and the contents of Y may be in virtual memory. Referencing the DAT switch allows only the determination of one memory type at a time. In the past, solutions have been proposed for determining the type of memory referenced in a single instruction. By way of example, in U.S. Pat. No. 7,318,174 to Lewis, the execution of a machine instruction upon a local virtual machine service supports two modes of referencing memory by register—“local” and “real.” Local refers to virtual memory accessible within the local virtual machine, while real refers to real memory accessible by the virtual machine.

### BRIEF SUMMARY OF THE INVENTION

Embodiments of the present invention provide a method, system and computer program product for maintaining dynamic register-level memory-mode flags in a virtual machine. In one embodiment, a method for maintaining dynamic register-level memory-mode flags in a virtual machine is provided. The method includes parsing a machine instruction of a live memory analysis command in a virtual machine. The machine instruction can include an instruction opcode, a source address referring to a first type of memory and a destination address referring to a second type of memory. By way of example, the first type of memory can be virtual memory and the second type of memory can be real memory, or vice versa.

A register bitmap can be stored as a register-level memory-mode flag array, such that each bit in the array represents a memory-mode status of a register. Thereafter, it can be determined whether or not the instruction opcode maps to an inheritance class. Finally, in response to a bit in the register-level memory mode flag array referencing virtual memory and the instruction opcode being mapped to an inheritance class, the register bitmap can be replaced with new bit values that represent redefined memory types for each register represented in the register bitmap. Subsequently, the new register bitmap can be used in simulation of a next machine instruction of a live memory analysis command executing in the virtual machine.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured to maintain dynamic register-level memory-mode flags.

FIG. 2 is a functional block diagram illustrating the code components of the virtual machine of FIG. 1;

FIG. 3 is a table illustrating four different inheritance classes that are determined based on looking up an instruction opcode; and,

FIG. 4 is a flow chart illustrating a process for maintaining dynamic register-level memory-mode flags in the virtual machine of FIG. 1.

### DETAILED DESCRIPTION OF THE INVENTION

Embodiments of the present invention provide a method for maintaining register-level memory-mode flags. In accordance with an embodiment of the present invention, a virtual machine can be initialized and local registers and local addresses can be created in the virtual machine. A machine instruction can be parsed in the virtual machine, including performing an opcode lookup for the machine instruction, assigning register bitmaps and resolving bitmap local status. Thereafter, the machine instruction can be simulated in the virtual machine. Of note, inherit and disinherit bitmaps can be initialized and it can be determined whether or not the machine instruction is an inheriting instruction. Subsequently, a new value for a local register bitmap can be resolved in order to determine whether a memory structure resides in dump or live memory and a target address can be defined as existing in both real and local memory. Finally, a copy of the memory structure can be returned.

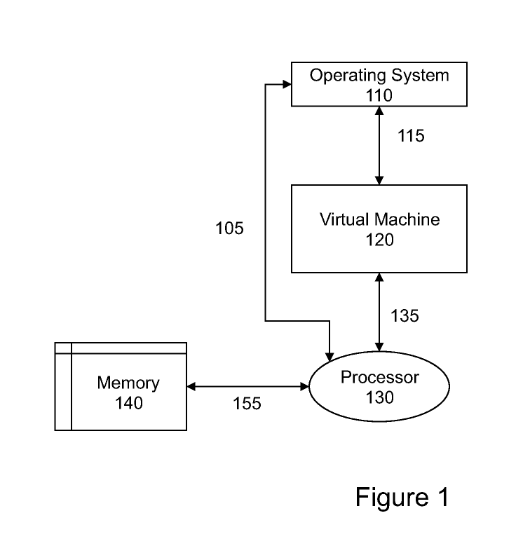

In further illustration, FIG. 1 schematically shows a data processing system configured to maintain dynamic register-level memory-mode flags. A computer system, in accordance with the present invention, can include hardware components, including a processor having a main operating system 110 with the ability to execute one or more guest operating systems (OS). The main operating system 110 can be any mainframe operating system, including but not limited to IBM z/VM or HP Superdome. Each guest OS can include program code enabled to allow a user to utilize a time sharing option (TSO) command. The TSO command can be configured to initiate a bug search command, which in return triggers the virtual machine to determine whether to refer to local memory or utilize an interprocess communicaiton system (IPCS) command to inspect real virtual memory.

The virtual machine 120 can be configured to execute a portion of the native TSO command, which typically can locate a control block structure within live memory in the virtual machine's 120 own virtual memory environment. By executing the memory location portion of the native TSO command in the virtual machine's 120 own virtual memory environment, the virtual machine 120 can be configured to provide a service for the native TSO command to gain access to other back end memory structures other than live memory 140. The virtual machine 120 can be configured to access a memory dump through IPCS by following the execution paths 115, 135, and 155 and data path 105. The virtual machine 120 can be configured to utilize execution path 135 when requesting the processor 130 to execute instructions requiring access to hardware components. Notably, operations specified in the native TSO command that are intended to access the processor 130 and live (local) memory 140 can be executed by the virtual machine 120 through execution path 115.

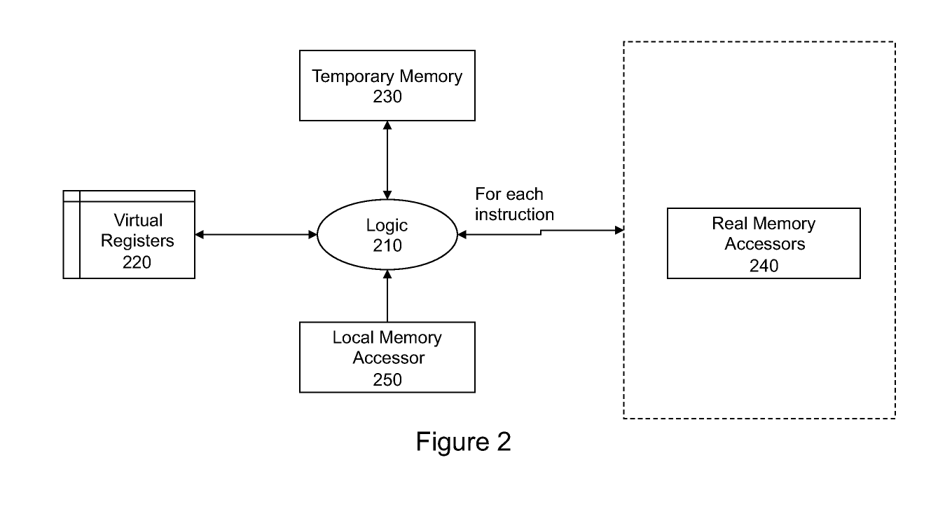

FIG. 2 illustrates a functional block diagram of the code components of the virtual machine of FIG. 1. The virtual machine includes memory-mode flag maintenance logic 210 coupled to virtual registers 220, pool of real memory accessors 240, and a local memory accessor 250 coupled to temporary memory 230. As shown in FIG. 2, virtual registers 220 include sixteen virtual registers and a program status word (PSW) construct, which emulate corresponding hardware registers and hardware PSW, respectively. Consequently, the memory mode flag maintenance logic 210 can be configured to determine that virtual registers 220 will be needed to process the command.

During the initialization of the virtual machine 120, the virtual machine 120 can be configured to poll the pool of real memory accessors 240. The first real memory accessor from the pool of real memory accessors 240 which respond to the poll and accept responsibility for the virtual machine's operating environment becomes the active real memory accessor. Preferably, the real memory accessor corresponding to a memory dump, for example, evaluates its set of requirements first before other real memory accessors evaluate theirs. The set of requirements for the real memory accessor corresponding to a memory dump includes making a determination that the IPCS tool is running on the computer system.

Since the native TSO command is not responsible for accessing the hardware registers or real machine memory directly, different memory types may be accessed by the native TSO command by simply adding a real memory accessor to the pool of real memory accessors 240 corresponding to a different memory type. The logic 210 can further be enabled to request the IPCS real memory accessor from the pool of real memory accessors 240 to access the memory dump via IPCS tool. Temporary memory 230 is accessible to the native TSO command operating environment. Thus, the data referenced by emulated instruction is returned to the native TSO command and the native TSO command's own operating environment.

The memory-mode flag maintenance logic can be configured to initialize the virtual machine (VM), and to define local registers and local addresses. Once initialization of the VM is complete, the memory-mode flag maintenance logic can be configured to parse each instruction in the locate code segment, assign an opcode instruction class from a lookup table, resolve bitmap local statuses, define target address, simulate the instruction and address, and update the local register bitmap (LBR) memory mode status and other structures in the VM. In short, the virtual machine 120 can be configured to receive a locate code segment, such as the locate code segment illustrated in Table 1 (below), perform the functions of the mainframe processor, determine whether a memory structure resides in dump or live memory by looking at both types of memory (by defining target address as existing in both real and/or local memory), return a copy of the memory structure and maintain memory-mode flags for upcoming functions of the mainframe processor.

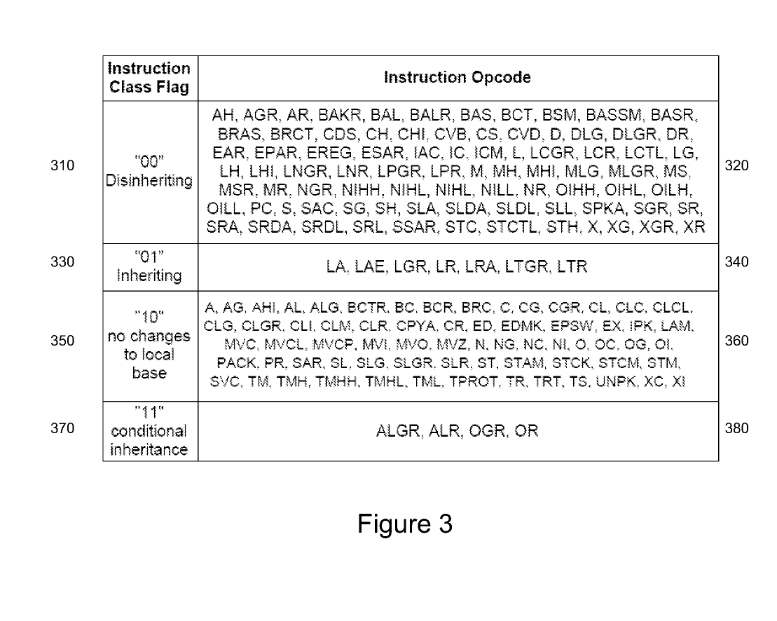

With respect to the assignment of an opcode instruction class from a lookup table, FIG. 3 is a table illustrating four different instruction class flags that are determined based on instruction opcode. When an instruction is parsed, the opcode can be classified into one of four instruction classes—00, 01, 10, and 11. The ‘00’ class flag 310 can correspond to disinheriting instruction opcodes 320, such as opcodes AH, AGR, AR, etc. The ‘01’ class flag 330 can correspond to inheriting instruction opcodes 340, such as opcodes LA, LAE, LGR, etc. The ‘10’ class flag 350 can correspond to ‘no changes’ to local base instruction opcodes 360, such as opcodes A, AG, AHI, etc. The ‘11’ class flag 370 can correspond to conditional inheritance instruction opcodes 380, such as opcodes ALGR, ALR, OGR etc.

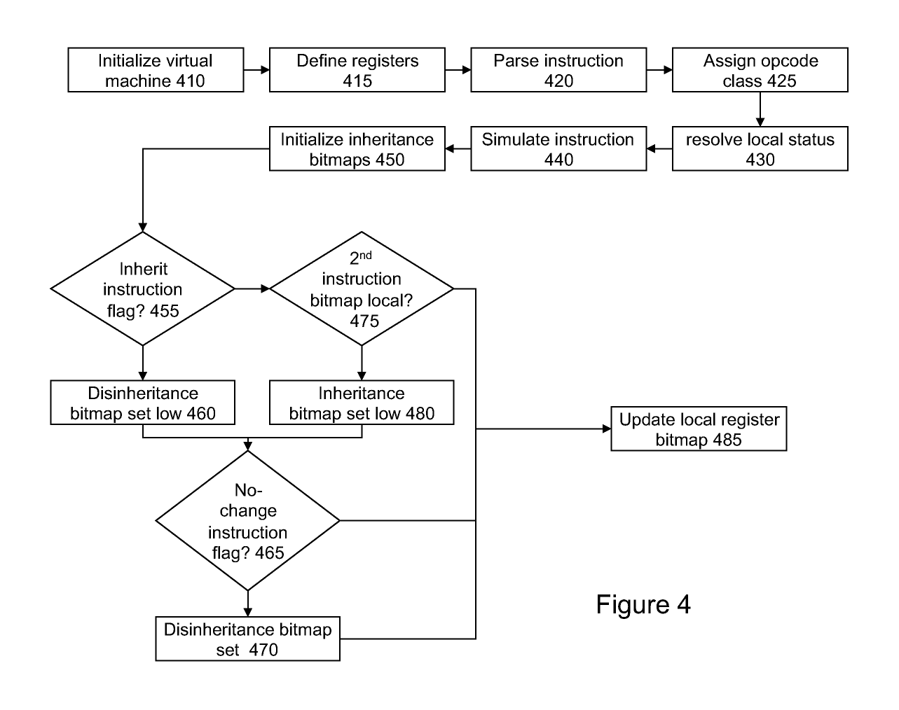

Table 1 is exemplary pseudo-code that represents a locate code segment used to modify native TSO commands to run in the virtual machine of FIG. 1. In essence, FIG. 4 exemplifies $IPCS macro code inserted into a native TSO command to modify the native TSO command in order to define a target address as existing in both real and local memory.

TABLE 1

$IPCS TYPE=START

| define r2, r3, r4 as local registers | |
|---|---|
| define 00005678 as a local address | |
| LA | R1,0(,R4) |
| LA | R2,444(,R0) |
| L | R3,0(,R2) |
| L | R2,0(,R1) |
| SR | R4,R4 |
| ALR | R2,R4 |
| ALR | R4,R2 |
| CLC | 0(4,R4),0(R3) |

$IPCS TYPE=END

Referring to Table 1, $IPCS macro pairs, “$IPCS TYPE=START” and “$IPCS TYPE=END” at the start and end of the locate code segment are used to suitably invoke or transfer control to a virtual machine, such as virtual machine 120 of FIG. 1. The virtual machine then can be configured to execute the locate code segment under the virtual machine's own operating environment.

In further implementation of the program code in Table 1, FIG. 4 is a flow chart illustrating a process for maintaining register-level memory-mode flags in the virtual machine of FIG. 1 in order to define a target address existing as both real memory and local memory. Starting in block 410, the VM can be initialized. As the VM initializes, the set of virtual registers are initialized to ‘real’ values as defined by the caller of the service—the TSO command program. In this regard, part of the initialization procedure allows the caller of the virtual machine to designate which registers are to be assumed initially to address areas of local memory.

Next in block 415, the local registers and local addresses can be defined in the virtual machine. Virtual registers that have low values point to real memory, which is also known as dump memory. In an exemplary scenario for example, in local memory—which is memory executing the TSO command—Register 4 can be assigned to hold the pointer address value ‘00001234.’

TABLE 2

| Location | Value | Type of Memory |
|---|---|---|
| Register 4 | 00001234 | Local |
| Address 00001234 | 00005678 | Local |
| Address 00005678 | XXXX | Local |
| Address 00000888 | 00000444 | Real |
| Address 00000444 | YYYY | Real |

To further continue the example scenario, as depicted above in Table 2, the pointer address 00001234 in local memory holds the address value ‘00005678’ which is the location where a data value can be stored in local memory. For example, the word at address 00005678 contains the value ‘XXXX.’ Similarly, the address 00008888 in real memory this time holds the pointer address value ‘00004444,’ which is the location where a data value can be stored in real memory. For example, in real memory (dump) the word at address 00004444 contains the value ‘YYYY.’ Before parsing each instruction, there is one more structure that needs to be defined in block 415—the local address list.

Table 3 exemplifies the Local Address List—which applies to special processing when load (L) and insert characters under mask (LRM) instructions are parsed. If the value loaded into the simulated virtual register matches an address of a local control block, the receiving instruction can be marked as local within the local register bitmap (LBR). Thus, by having the local address list, it is possible to create a list of ‘exceptions’ that the special processing mentioned above will be able to reference.

TABLE 3

| | | | | |
|---|---|---|---|---|
| Local Address List | 0-0-0-0-0-0-0-0 | 0-0-0-0-0-0-0-0 | 0-0-0-0-0-0-0-0 | 0-0-0-0-0-0-0-0 |

In block 415, defining local registers in the virtual machine provides ability of the program code to define additional registers as having a “Local Base” status. Each bit of the local register bitmap represents the memory mode for local registers. High values, such as “1” in the local register bitmap, represent local memory; low values, such as “0,” represent real memory for registers 0 & 1, and registers 5 through 9.

For defining local addresses, in block 415, address 00005678 is defined as representing a local memory. The local address list now appears as:

TABLE 3

| | | | | |
|---|---|---|---|---|
| Local Address List | 0-0-0-0-5-6-7-8 | 0-0-0-0-0-0-0-0 | 0-0-0-0-0-0-0-0 | 0-0-0-0-0-0-0-0 |

Once the local addresses and local registers have been defined for each and every machine instruction simulated by the local virtual machine, the instruction can be parsed in block 420. During instruction parsing, the instruction is assigned values for register-bitmap-1 (RB1) and register-bitmap-2 (RB2) based on the format of the instruction, the specific instruction opcode, and the registers specified in the instruction. Referring to Table 1, the instruction in the pseudo-code after defining local registers and defining local addresses is “LA R1,0,(R4).” R1 in the instruction is treated as the B1 position in RB1, thus a “1” gets assigned at the R1 position of RB1 becoming 0100 0000 0000 0000. R4 in the instruction is treated as the B2 position in RB2, thus a “1” gets assigned at the R4 position of RB2 becoming 0000 1000 0000 0000.

Based on the instruction opcode, each instruction parsed is put into one of four classes and given a class flag two-bit value of either “00,” “01,” “10,” or “11” in block 425. The class flags can be assigned from the lookup table in FIG. 3 as mentioned above. In this instance, for the first opcode instruction, the assigned opcode instruction class flag would be “01” since “LA” is an inheriting instruction according to the lookup table of FIG. 3.

Next in block 430 B1 and B2 local statuses can be resolved. To resolve B1 local status, the instruction's register-bitmap-1 is compared to the current settings for the local-register bitmap (LBR). If the “AND”ed result of the two bitmaps is nonzero, then the instruction is deemed “B1” local. To resolve B2 local status, the instruction's register-bitmap-2 is compared to the current settings for the local-register bitmap (LBR). If the “AND”ed result of the two bitmaps is nonzero, then the instruction is deemed “B2” local.

Next in block 440, the instruction is simulated using the “B1” and “B2” local flags to drive the switch between “Local” and “Real” memory access routines. Additionally, the target address can be defined. If B2 local status is a non-zero, the target address is defined as existing in local memory. If B2 local status is a zero then the target address is defined as existing in real memory (also known as dump memory).

The rest of the blocks in FIG. 4 illustrate how an “overall-inheritance” and an “overall-disinheritance” bitmap can be generated. In block 450, the inherit (INH) and disinherit (DIS) bitmaps can be initialized. To initialize the INH bitmap all values can be set using R1 in the B1 position referring to the “LA R1,0,(R4)” in Table 1, as an exemplary implementation.

Next in decision block 455, if the opcode instruction class flag is “01” or “11” then decision block 475 is determined. If B2 has local status (high value) then the LBR is set as appropriate block 480. If in decision block 455, the opcode instruction class flag is “00” or “10” then in block 460 the DIS bitmap is set to all low values “0.” If there is a no change instruction determined in decision block 465, meaning the opcode instruction class flag is “00” or “01” then in block 470 the DIS bitmap is changed to the complement of RB1. Thereafter, the LBR can be updated in block 485.

In block 485, the local register bitmap (LBR) is updated by “AND”ing the prior value for the LBR bitmap with the “overall-disinheritance” DIS bitmap, and “OR”ing that result with the “overall-inheritance” INH bitmap. Lastly, special processing occurs for the L (load) and ICM (insert characters under mask) instructions. If the value loaded into the simulated general register corresponds to an address of a local control block, the receiving instruction is marked as local within the LBR bitmap.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s).

It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Also note that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process, such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for maintaining dynamic register-level memory-mode flags in a virtual machine comprising:
parsing a machine instruction of a live memory analysis command in a virtual machine, wherein the machine instruction comprises an instruction opcode, a source address referring to a first type of memory and a destination address referring to a second type of memory;
storing a register bitmap as a register-level memory-mode flag array, wherein each bit in the array represents a memory-mode status of a register;
determining whether or not the instruction opcode maps to an inheritance class; and,
responsive to a bit in the register-level memory mode flag array referencing virtual memory and the instruction opcode being mapped to an inheritance class, replacing the register bitmap with new bit values that represent redefined memory types for each register represented in the register bitmap, wherein the new register bitmap is used in simulation of a next machine instruction of a live memory analysis command executing in the virtual machine.

2. The method of claim 1, further comprising simulating the machine instruction in the virtual machine.

3. The method of claim 1, wherein the first type of memory is real memory and the second type of memory is virtual memory.

4. A computer program product for maintaining dynamic register-level memory-mode flags in a virtual machine s, the computer program product comprising:
a computer readable storage medium having computer readable program code embodied therewith, the computer readable program code comprising:
computer readable program code for parsing a machine instruction of a live memory analysis command in a virtual machine, wherein the machine instruction comprises an instruction opcode, a source address referring to a first type of memory and a destination address referring to a second type of memory;
computer readable program code for storing a register bitmap as a register-level memory-mode flag array, wherein each bit in the array represents a memory-mode status of a register;
computer readable program code for determining whether or not the instruction opcode maps to an inheritance class; and,
computer readable program code for replacing the register bitmap with new bit values that represent redefined memory types for each register represented in the register bitmap in response to a bit in the register-level memory mode flag array referencing virtual memory and the instruction opcode being mapped to an inheritance class, wherein the new register bitmap is used in simulation of a next machine instruction of a live memory analysis command executing in the virtual machine.

5. The computer program product of claim 4, further comprising computer readable program code for simulating the machine instruction in the virtual machine.

6. The computer program product of claim 4, wherein the first type of memory is real memory and the second type of memory is virtual memory.

7. A virtual machine data processing system configured for dynamic register-level memory-mode flags in a virtual machine comprising:
a computer with at least one processor and memory;
a virtual machine executing in the memory of the computer; and,
memory mode flag maintenance logic executing in the computer, the logic comprising program code enabled to parse a machine instruction of a live memory analysis command in the virtual machine, wherein the machine instruction comprises an instruction opcode, a source address referring to a first type of memory and a destination address referring to a second type of memory, to store a register bitmap as a register-level memory-mode flag array, wherein each bit in the array represents a memory-mode status of a register, to determine whether or not the instruction opcode maps to an inheritance class, and to respond to a bit in the register-level memory mode flag array referencing virtual memory and the instruction opcode being mapped to an inheritance class, by replacing the register bitmap with new bit values that represent redefined memory types for each register represented in the register bitmap, wherein the new register bitmap is used in simulation of a next machine instruction of a live memory analysis command executing in the virtual machine.

8. The system of claim 7, wherein the first type of memory is real memory and the second type of memory is virtual memory.
